(19) United States
(12) Patent Application Publication
(10) Pub. No.: US 2013/0194147 A1
(43) Pub. Date: Aug. 1, 2013

(54) ANTENNA DEVICE

(71) Applicant: Hiroki YOSHIOKA, Kawasaki-shi (JP)

(72) Inventor: Hiroki YOSHIOKA, Kawasaki-shi (JP)

(73) Assignee: MITSUMI ELECTRIC CO., LTD., Tokyo (JP)

(21) Appl. No.: 13/751,779

(22) Filed: Jan. 28, 2013

(30) Foreign Application Priority Data
Feb. 1, 2012 (JP) 2012-019505

(51) Int. Cl. H01Q 1/38

(52) U.S. Cl. CPC H01Q 1/38
USPC 343/787

(57) ABSTRACT

A patch antenna as an antenna device comprises an antenna electrode, a ground portion, an antenna substrate and a feed point. A feed angle F_{ang} which is an angle of the feed point is larger than a characteristic curve of a feed angle of a patch antenna having an antenna substrate composed of only a dielectric in terms of the feed angle with respect to a shortening rate based on a relative permittivity and a relative magnetic permeability of the antenna substrate. The feed angle is an angle based on a middle axis between long and short axes in a direction of rotation from the short axis to the long axis around a central point of the plane of the antenna electrode. The long axis is a current route which is the longest in the antenna electrode and the short axis is orthogonal thereto.

### BACKGROUND OF THE INVENTION

1. Field of the Invention

This invention relates to an antenna device for circularly polarized communication.

2. Description of the Related Arts

Patch antennas are conventionally known as antenna devices for high frequency communication. The patch antennas are used for GPS (Global Positioning System) antennas and ETC (Electronic Toll Collection System) antennas, for example.

Herein, a description is given of a configuration of a conventional patch antenna 80 with reference to FIG. 21. FIG. 21 is a plan view of the patch antenna 80.

The patch antenna 80 is a single-feed patch antenna for circularly polarized communication. As shown in FIG. 21, the patch antenna 80 includes an antenna substrate 81, an antenna electrode 82, a ground portion 83, and a feed pin 84.

The antenna substrate 81 is a substrate which is made of a dielectric such as ceramic and is cuboid with a square upper surface. The antenna electrode 82 is a metallic electrode formed on the upper surface of the antenna substrate 81. The ground portion 83 is a metallic ground plate which is provided on the lower surface of the antenna substrate 81 and is grounded. The feed pin 84 is a metallic feed pin which is electrically connected to the antenna electrode 82 and penetrates the antenna substrate 81, the antenna electrode 82, and the ground portion 83. The connection point of the feed pin 84 and the antenna electrode 82 is indicated as a feed point P.

Use of the antenna substrate 81 allows miniaturization of the patch antenna 80 because of the wavelength shortening effect due to the relative permittivity of the dielectric of the antenna substrate 81.

The antenna electrode 82 has a shape of a square electrode with a pair of opposing corners truncated arid includes perturbation elements 821 as degeneracy separation elements. Use of the perturbation elements 821 causes two resonant modes in the antenna electrode 82. Specifically, the antenna electrode 82 has a current route which is the longest in the electrode and a current route orthogonal to the longest, current route. The electrode length of the longest current route is referred to as a long-axis length L1. The electrode length of the current route orthogonal to the current route of the long-axis length L1 is referred to as a short-axis length L2. By applying antenna current to the feed pin 84 so that the resonant mode of the long-axis length L1 and the resonant mode of the short-axis length L2 have the same amplitude and a phase difference of 90 degrees, circularly polarized radio waves are radiated from the patch antenna 80. The resonant modes of the long-axis length L1 and the short-axis length L2 are referred to as first and second modes, respectively.

In some known patch antennas, the antenna substrates are made of magnetic materials (for example, refer to Japanese Patent Laid-open Publication No. 2000-82914). Moreover, in other patch antennas, the antenna substrates are made of magnetic composites (magnetic dielectrics) (for example, refer to Japanese Patent Laid-open Publication No. 2011-49802). The magnetic composites have similar relative permittivity to those of dielectrics and have similar relative magnetic permeability to those of magnetic materials. The shortening rate SR due to the wavelength shortening effect is expressed by the following equation (1).

SR=1/(εr·μr)^{1/2} (1)

Herein, εr is the relative permittivity, and μr is the relative magnetic permeability.

Accordingly, the patch antenna can be also miniaturized by using the antenna substrate made of a magnetic material or magnetic composite.

In addition, with reference to FIGS. 22A and 22B, a description is given of distributions of current amplitude and current phase with respect to the frequency in the patch antenna 80 in which the antenna substrate 81 is made of a dielectric or magnetic composite. FIG. 22A is a diagram showing the distribution of current amplitude with respect to frequency in the patch antenna 80 in which the antenna substrate 81 is made of a dielectric or magnetic composite. FIG. 22B is a diagram showing the distribution of current phase with respect to frequency in the patch antenna 80 in which the antenna substrate 81 is made of a dielectric or magnetic composite.

As shown in FIGS. 22A and 22B, a frequency fa1 is the resonant frequency corresponding to the long-axis length L1 of the patch antenna 80 including the antenna substrate 81 made of the dielectric, and a frequency fa2 is the resonant frequency corresponding to the short-axis length L2 of the patch antenna 80 including the antenna substrate 81 made of the dielectric. A frequency f1 is the resonant frequency corresponding to the long-axis length L1 of the patch antenna 80 including the antenna substrate 81 made of the magnetic composite, and a frequency f2 is the resonant frequency corresponding to the short-axis length L2 of the patch antenna 80 including the antenna substrate 81 made of the magnetic composite. The central frequency of the frequencies of fa1 and fa2 and the central frequency of the frequencies f1 and f2 are referred to as a frequency f0.

The requirements for generating circularly polarized waves in the patch antenna 80 are that: the amplitudes of the first and second modes corresponding to the long-axis length L1 and short-axis length L2 are equal to each other and the phase difference between the first and second modes is 90 degrees. Generally, with regard to the amplitude and phase, as the patch antenna 80 is miniaturized by including the antenna substrate 81 made of a dielectric, as shown in FIG. 22A, the range between the frequencies fa1 and fa2 is reduced. At this time, if the range between the frequencies fa1 and fa2 is excessively narrow, as shown in FIG. 22B, the phase difference cannot have 90 degrees or more. On the other hand, in the patch antenna 80 including the antenna substrate 81 made of the magnetic composite, the range between the frequencies f1 and f2 is comparatively wide, and the phase difference can have easily 90 degrees or more.

Generally, it is known that an antenna including an antenna substrate made of a magnetic material has high input impedance and the bandwidth thereof is wide. As shown in FIGS. 22A and 22B, it is already confirmed that use of the magnetic composite for the antenna substrate of a patch antenna can increase the bandwidth. However, specific structural values appropriate to cause the patch antenna including an antenna substrate made of a magnetic composite to radiate circularly polarized waves remain to be determined.

### SUMMARY OF THE INVENTION

An object of the present invention is to implement good circularly polarized radiation (reception) in an antenna device including a magnetic composite.

According to an aspect of the present invention, there is provided an antenna device, comprising:

a planar antenna electrode;

a planar ground portion;

an antenna substrate which is sandwiched by the antenna electrode and the ground portion and is made of a magnetic composite containing a dielectric and a magnetic material; and

a feed point connected to the antenna electrode, wherein

a feed angle which is an angle of the feed point is larger than a characteristic curve of a feed angle of a patch antenna having an antenna substrate composed of only a dielectric in terms of the feed angle with respect to a shortening rate based on a relative permittivity and a relative magnetic permeability of the antenna substrate, the feed angle being an angle based on a middle axis between a long axis and a short axis in a direction of rotation from the short axis to the long axis around a central point of the plane of the antenna electrode, the long axis being a current route which is the longest in the antenna electrode, the short axis being orthogonal to the long axis. Preferably, the antenna electrode has a shape of a square electrode with a pair of opposing corners thereof removed, and the characteristic curve of the feed angle of the patch antenna including the antenna substrate composed of only the dielectric is expressed as:

F_{ang} [deg.]=15 tan⁻¹(15SR−0.5)−17

where F_{ang} is the feed angle and SR is the shortening rate.

Preferably, the antenna electrode is a rectangular electrode, and the characteristic curve of the feed angle of the patch antenna including the antenna substrate composed of only the dielectric is expressed as:

F_{ang} [deg.]=20 tan⁻¹(16SR−2.2)−22

where F_{ang} is the feed angle and SR is the shortening rate.

Preferably, the shortening rate based on the relative permittivity and the relative magnetic permeability of the antenna substrate is not more than 0.4.

### BRIEF DESCRIPTION OF THE DRAWINGS

FIG. 1A is a perspective view of a patch antenna of a first embodiment according to the present invention, and FIG. 1B is a perspective view of a patch antenna obtained by miniaturization of the patch antenna of FIG. 1A.

FIG. 2A is a plan view of the patch antenna of the first embodiment, illustrating a long-axis length, a short-axis length, and the like, and FIG. 2B is a plan view of the patch antenna of the first embodiment, illustrating a feed angle indicating the position of a feed point and the like.

FIG. 3 is a diagram showing distributions of the feed angle with respect to the shortening rate in a dielectric patch antenna and the patch antenna of the first embodiment.

FIG. 4 is a diagram showing distributions of the radiation efficiency with respect to the shortening rate in the dielectric patch antenna and the patch antenna of the first embodiment.

FIG. 5 is a diagram showing distributions of the long-to-short axis ratio with respect to the shortening rate in the dielectric patch antenna and the patch antenna of the first embodiment.

FIG. 6 is a diagram showing distributions of the ratio of length between the center and the feed point with respect to the shortening rate in the dielectric patch antenna and the patch antenna of the first embodiment.

FIG. 7 is a diagram illustrating a range of the feed angle to the shortening rate which is applicable in the patch antenna of the first embodiment,

FIG. 8 is a plan view of a patch antenna of a second embodiment of the present invention.

FIG. 9 is a diagram showing distributions of the feed angle with respect to the shortening rate in a dielectric patch antenna and the patch antenna of the second embodiment.

FIG. 10 is a diagram showing distributions of the radiation efficiency with respect to the shortening rate in the dielectric patch antenna and the patch antenna of the second embodiment.

FIG. 11 is a diagram showing distributions of the long-to-short axis ratio with respect to the shortening rate in the dielectric patch antenna and the patch antenna of the second embodiment.

FIG. 12 is a diagram showing distributions of the ratio of length between the center and the feed point with respect to the shortening rate in the dielectric patch antenna and the patch antenna of the second embodiment.

FIG. 13 is a diagram illustrating a range of the feed angle with respect to the shortening rate which is applicable in the patch antenna of the second embodiment.

FIG. 14A is a plan view of a first antenna electrode of a modification; FIG. 14B is a plan view of a second antenna electrode of a modification; FIG. 14C is a plan view of a third antenna electrode of a modification; FIG. 14D is a plan view of a fourth antenna electrode of a modification; and FIG. 14E is a plan view of a fifth antenna electrode of a modification.

FIG. 15 is a table showing numerical values of the first parameters of the patch antenna.

FIG. 16 is a table showing numerical values of the second parameters of the patch antenna.

FIG. 17 is a table showing numerical values of the third parameters of the patch antenna.

FIG. 18 is a table showing numerical values of the fourth parameters of the patch antenna.

FIG. 19 is a table showing numerical values of the fifth parameters of the patch

FIG. 20 is a table showing numerical values of the sixth parameters of the patch antenna.

FIG. 21 is a plan view of a patch antenna of a conventional example.

FIG. 22A is a diagram showing distributions of current amplitude with respect to frequency in the patch antenna of the conventional example in which the antenna substrate is made of a dielectric or a magnetic composite, and FIG. 22B is a diagram showing distributions of current phase with respect to frequency in the patch antenna of the conventional example in which the antenna substrate is made of a dielectric or a magnetic composite.

### DESCRIPTION OF THE PREFERRED EMBODIMENTS

Hereinafter, with reference to the accompanying drawings, a description is given of first and second embodiments and modifications according to the present invention sequentially in detail. The scope of the invention is not limited to the examples shown in the drawings.

### First Embodiment

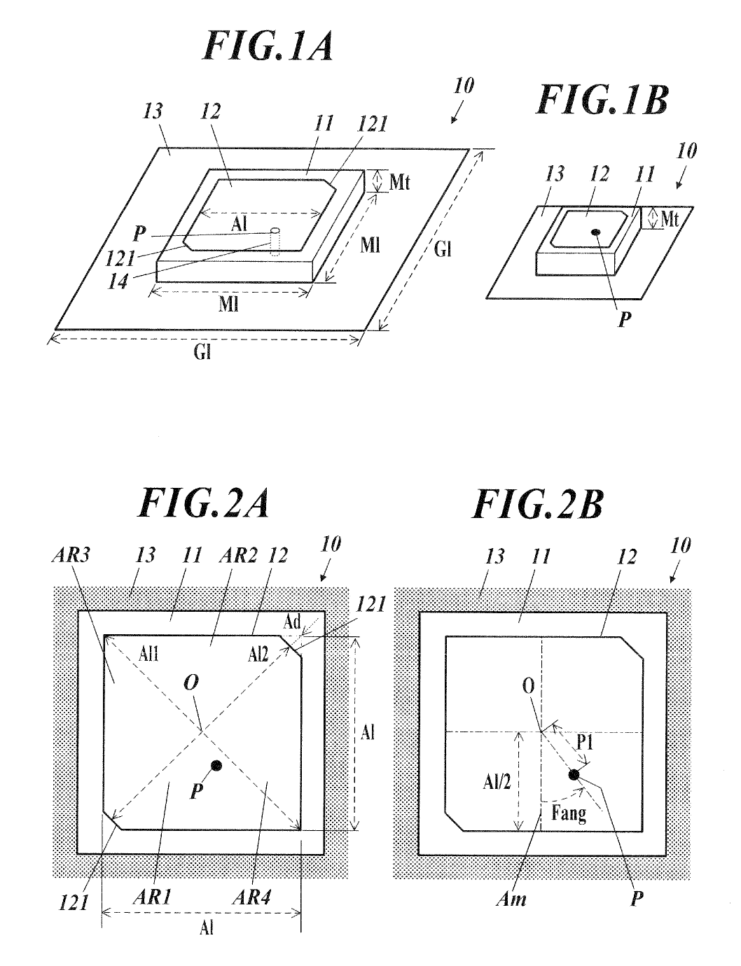

With reference to FIGS. 1A to 7, the first embodiment of the present invention is described. First, with reference to FIGS. 1A and 18 and FIGS. 2A and 2B, a description is given of a device configuration of a patch antenna 10 as an antenna device of the first embodiment. FIG. 1A is a perspective view of the patch antenna 10. FIG. 1B is a perspective view of a miniaturized patch antenna 10. FIG. 2A is a plan view of the patch antenna 10, illustrating a long-axis length Al1, a short-axis length Al2, and the like. FIG. 2B is a plan view of the patch antenna 10, illustrating a feed angle F_{ang} indicating the position of a feed point P and the like.

The patch antenna 10 of the first embodiment is a single-feed patch antenna for circularly polarized communication of a corner-truncated model. In the example described below, the patch antenna 10 is a GPS antenna receiving GPS signals as right circularly polarized waves emitted from GPS satellites. However, the present invention is not limited to the configuration in which the patch antenna 10 is a GPS antenna.

As shown in FIG. 1A, the patch antenna 10 includes an antenna substrate 11, an antenna electrode 12, a ground portion 13, and a feed pin 14.

The antenna substrate 11 is a substrate which is made of a magnetic composite and is cuboid with a square upper surface. The magnetic composite of the antenna substrate 11 is a material containing a magnetic material and a dielectric and is composed of a bulk material in which magnetic particles of iron, ferrite, or the like are dispersed in an insulating dielectric resin or inorganic dielectric. However, the magnetic composite of the antenna substrate 11 is not limited to the aforementioned materials and may have a configuration in which a magnetic thin film is formed on the surface of a dielectric.

The antenna electrode 12 is a metallic electrode of silver foil, copper foil, or the like and is formed on the upper surface of the antenna substrate 11. The antenna electrode 12 has a shape obtained by a square electrode with a pair of opposing corners removed and includes perturbation elements 121 as degeneracy separation elements.

The ground portion 13 is a metallic square ground plate, such as a copper plate, which is provided on the lower surface of the antenna substrate 11 and is grounded. The antenna substrate 11 is sandwiched by the antenna electrode 12 and the ground portion 13. In the antenna device 10, a metallic ground electrode may be formed on the lower surface of the antenna substrate 11. This ground electrode has the same planer shape as the antenna substrate 11, for example.

The feed pin 14 is a metallic feed pin which is electrically connected to the antenna electrode 12 and penetrates the antenna substrate 11 and the ground portion 13. The feed pin 14 is not electrically connected to the ground portion 13. The connection point of the feed pin 14 and the antenna electrode 12 is a feed point P.

The relative permittivity of the magnetic composite of the antenna substrate 11 is indicated by εr, and the relative magnetic permeability thereof is indicated by μr. The antenna characteristics of the patch antenna 10 are analyzed by varying the relative permittivity εr the relative magnetic permeability μr of the magnetic composite of the antenna substrate 11.

Next, a description is given of parameters of each portion of the patch antenna 10. As shown in FIG. 1A, the length of each side of the planar square of the antenna substrate 11 is referred to as a length Ml [mm]. The length of each side of the square of the ground portion 13 is referred to as a length Gl [mm]. Herein, Gl=2×Ml. The length of each side of a square of the antenna electrode 12 with the perturbation elements 121 not removed is referred to as a length Al [mm]. Al=0.8×Ml. The thickness of the antenna substrate 11 is referred to as a thickness Mt [mm], which is fixed as Mt=2 [mm].

If the relative permittivity εr and the relative magnetic permeability μr of the magnetic composite of the antenna substrate 11 are increased, because of the wavelength shortening effect expressed as the shortening rate of the above equation (1), the parameters of the lengths of the patch antenna 10 other than the thickness Mt [mm] are reduced, and the patch antenna 10 is miniaturized, as shown in FIG. 1B.

As shown in FIG. 2A, the provision of the perturbation elements 121 causes two resonant modes in the antenna electrode 12. The antenna electrode 12 includes a current route which is the longest in the electrode and a current route orthogonal to the longest current route. The electrode length of the longest current route is referred to as a long-axis length Al1. The electrode length of the current route orthogonal to the longest current route is referred to as Al2. If antenna current is applied to the feed pin 14 so that the amplitudes of the resonant modes of the long-axis length Al1 and the short-axis length Al2 are equal to each other and the phase difference therebetween is 90 degrees, circularly polarized radio waves are radiated from the patch antenna 10. The resonant modes of the long-axis length Al1 and the short-axis length Al2 are referred to as first and second modes, respectively.

The length of each perturbation element 121 on the extension of the axis (short axis) of the short-axis length Al2 is referred to as a length Ad [mm]. The central point of the plane of the antenna electrode 12, which is an intersection of the short-axis and the axis (long axis) of the long-axis length Al1, is referred to as a central point O.

The antenna electrode 12 is separated into four areas AR1, AR2, AR3, and AR4 by the long axis and the short axis. When the feed point P is provided in the area AR1 or AR2, the patch antenna 10 radiates right circularly polarized waves. The GPS signals are right circularly polarized.

As shown in FIG. 2B, the ratio of length P1 between the central point O and the feed point P to A1/2 is indicated by Fr. Moreover, the middle axis between the long axis and the short axis is referred to as an axis Am. The angle of the feed point P with respect to the axis Am as a standard is referred to as a feed angle F_{ang} [deg. (degree)]. Herein, in a direction of counterclockwise rotation from the short axis to the long axis around the central point O, the direction from the short axis to the long axis is set positive. The distance between the central point O and the edge of the antenna electrode 12 along the axis Am is A1/2.

The design requirements of the patch antenna 10 are that good right circularly polarized waves are generated at the frequency of GPS signals of 1.575 (GHz). More specifically, the deign requirements of the patch antenna 10 are that the following equations (2) and (3) are satisfied at the frequency of 1.575 [GHz].

VSWR (voltage standing wave ratio)<1.5 (2)

Axial ratio [dB]<1.0 (3)

In the specifications of general GPS antennas, VSWR<2, and the axial ratio [dB]<3 at the frequency of 1.57542 [GHz].

Next, a description is given of numerical values of the parameters of the patch antenna 10 in the case of varying the relative permittivity εr and the relative magnetic permeability μr of the antenna substrate 11.

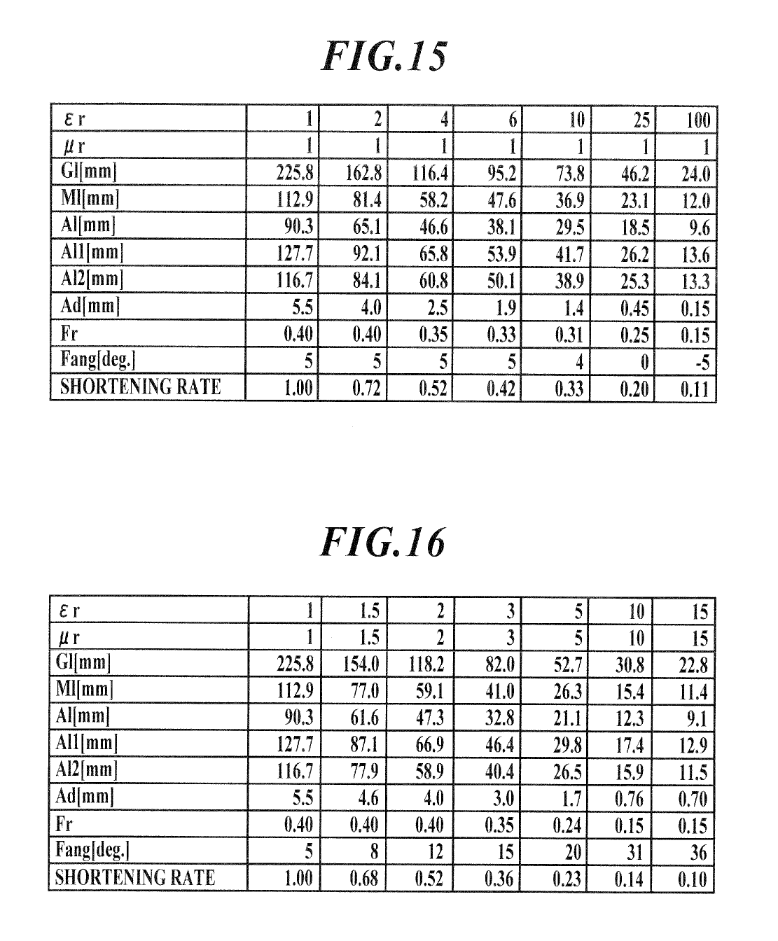

First, for comparison with the patch antenna 10, FIG. 15 shows numerical values of the first parameters of a patch antenna which has the same shape as the patch antenna 10 and includes an antenna substrate made of a dielectric. The relative permittivity εr of the dielectric is changed while the relative magnetic permeability μr being fixed to 1. The dielectric loss tan δμ of the dielectric is set to 0.001, and the magnetic loss tan δμ of the same is set to 0. The shortening rate SR is expressed as the equation (1) described above.

FIG. 16 shows numerical values of the second parameters of the patch antenna 10 in which the antenna substrate 11 is composed of a magnetic composite having a ratio (εr:μr) of 50:50. The values of the ratio of the relative permittivity εr to the relative magnetic permeability μr in (εr:μr) are expressed in percentage, and the same goes for the following description. The dielectric loss tan δε of the magnetic composite of the antenna substrate 11 is set to 0.001, and the magnetic loss δμ of the same is set to 0.001. The same goes for the following description.

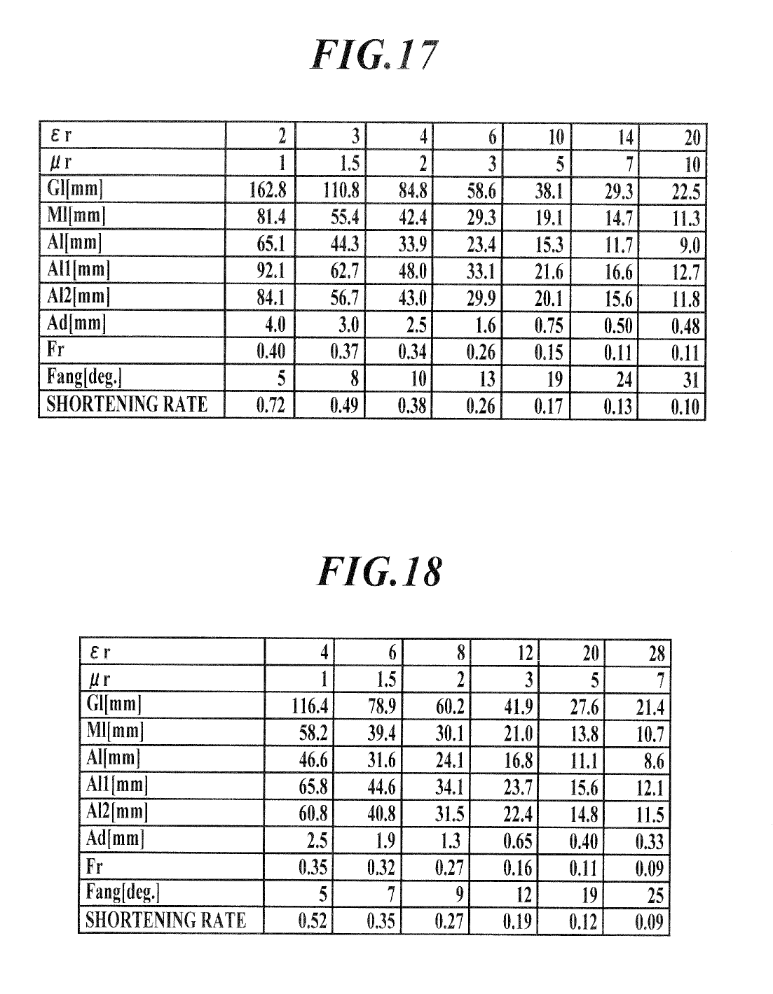

FIG. 17 shows numerical values of the third parameters of the patch antenna 10 in which the antenna substrate 11 is composed of a magnetic composite having a ratio (εr:μr) of (66.7:33.3).

FIG. 18 shows numerical values of the fourth parameters of the patch antenna 10 in which the antenna substrate 11 is composed of a magnetic composite having a ratio (εr:μr) of (80:20).

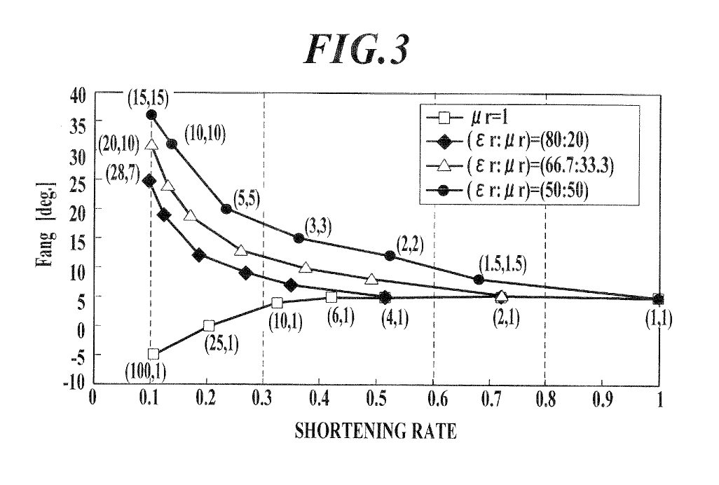

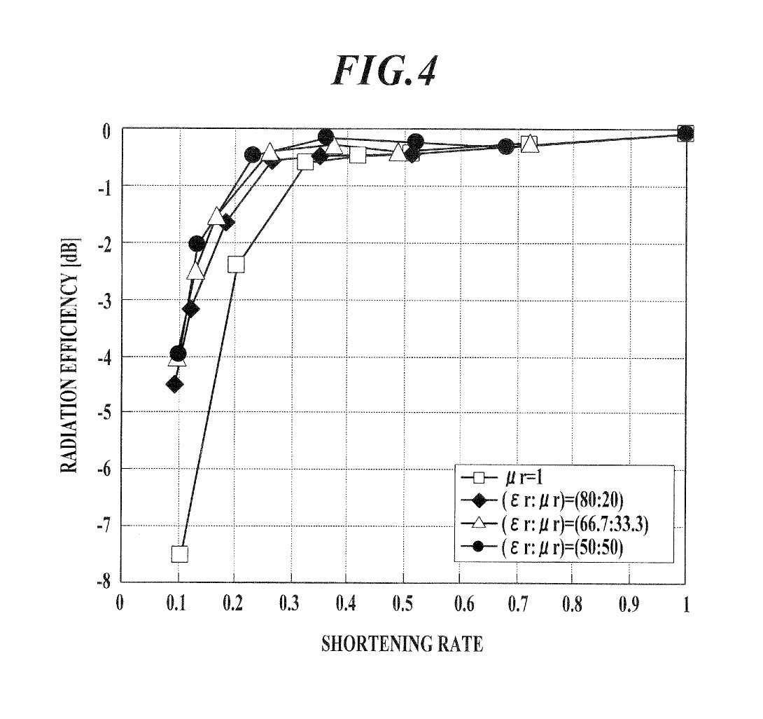

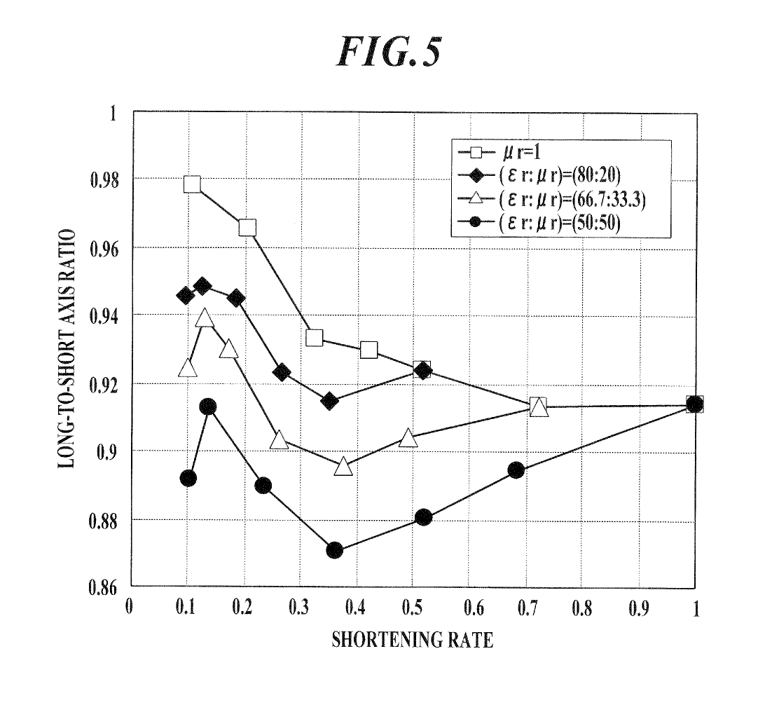

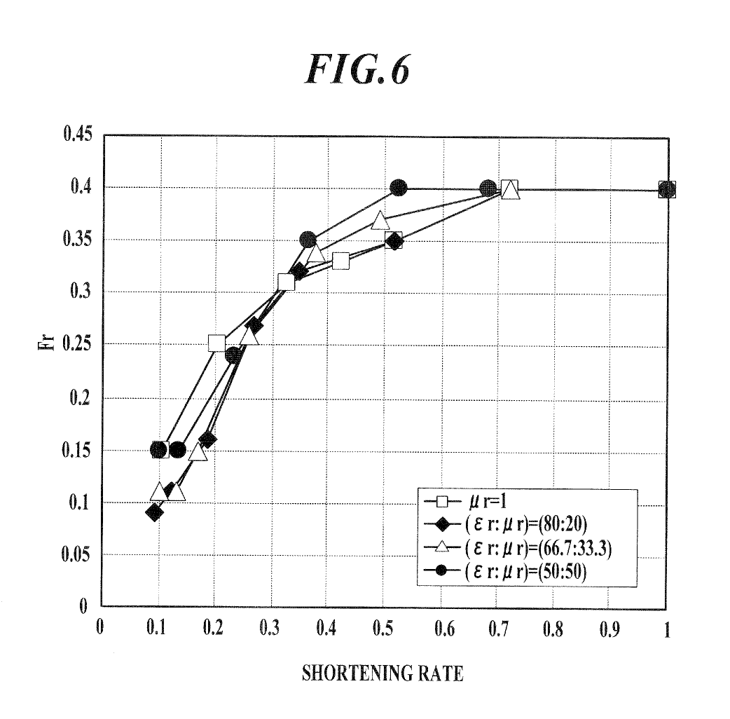

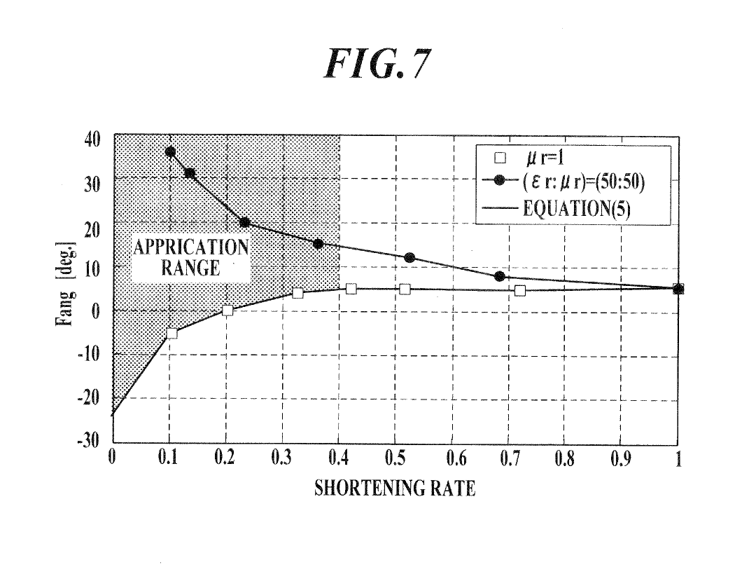

Next, with reference to FIGS. 3 to 7, a description is given of the analysis results of the antenna characteristics and the parameters with respect to the shortening rate in the dielectric patch antenna and the patch antenna 10 which are described in FIGS. 15 to 18. FIG. 3 is a diagram showing distributions of the feed angle F_{ang} with respect to the shortening rate SR in the dielectric patch antenna and the patch antenna 10. FIG. 4 is a diagram showing distributions of the radiation efficiency with respect to the shortening rate SR in the dielectric patch antenna and the patch antenna 10. FIG. 5 is a diagram showing distributions of the long-to-short axis ratio with respect to the shortening rate SR in the dielectric patch antenna and the patch antenna 10. FIG. 6 is a diagram showing distributions of Fr with respect to the shortening rate SR in the dielectric patch antenna and the patch antenna 10. FIG. 7 is a diagram showing a range (application range: dotted area) of the feed angle F_{ang} with respect to the shortening rate SR which is applicable to the patch antenna 10.

Herein, the antenna electrode 12 and the ground portion 13 are respectively made of copper. The conductivity of copper is 5.8×10⁷ [S/m]. In FIGS. 3 to 6, concerning the patch antenna in which an antenna substrate is made of a dielectric and the patch antenna 10 in which the antenna substrate 11 is made of a magnetic composite having a ratio (εr:μr) of (80:20), (66.7:33.3), or (50:50), the points satisfying the requirements to provide good right circularly polarized waves of a frequency of 1.575 [GHz], or satisfying the equations (2) and (3) at the frequency of 1.575 [GHz] are plotted. Concerning the respective plotted points, the higher the shortening rate, the lower the relative permittivity εr and the relative magnetic permeability μr, and the lower the shortening rate, the higher the relative permittivity εr and the relative magnetic permeability μr.

As shown in FIG. 3, concerning the patch antenna including the dielectric antenna substrate and the patch antenna 10 in which the antenna substrate 11 is made of a magnetic composite having a ratio (εr:μr) of (80:20), (66.7:33.3), or (50:50), the distributions of the feed angle F_{ang} with respect to the shortening rate SR are obtained. In FIG. 3, (X, Y)=(εr:μr). Herein, X and Y are variables of εr and μr, respectively. As for the patch antenna including the dielectric antenna substrate, as the shortening rate SR is reduced, the feed angle F_{ang} is reduced. In the patch antenna 10 in which the antenna substrate 11 is made of a magnetic composite having a ratio (εr:μr) of (80:20), (66.7:33.3), or (50:50), as the shortening rate SR decreases, the feed angle F_{ang} increases. Moreover, the feed angle F_{ang} of the patch antenna 10 is larger than that of the patch antenna including the dielectric antenna substrate.

As shown in FIG. 4, concerning the patch antenna including the dielectric antenna substrate and the patch antenna 10 in which the antenna substrate 11 is made of a magnetic composite having a ratio (εr:μr) of (80:20), (66.7:33.3), or (50:50), the radiation efficiency with respect to the shortening rate SR is obtained. In the patch antenna including the dielectric antenna substrate and the patch antenna 10 in which the antenna substrate 11 is made of a magnetic composite having a ratio (εr:μr) of (80:20), (66.7:33.3), or (50:50), as the shortening rate SR is reduced, the radiation efficiency is reduced. When the shortening rate SR is reduced to 0.4 or less, in particular, the radiation efficiency is reduced drastically.

As shown in FIG. 5, concerning the patch antenna including the dielectric antenna substrate and the patch antenna 10 in which the antenna substrate 11 is made of a magnetic composite having a ratio (εr:μr) of (80:20), (66.7:33.3), or (50:50), the distributions of the long-to-short axis ratio with respect to the shortening rate SR are obtained. The long-to-short axis ratio is expressed by the following equation (4).

Al2/Al1 (4)

The values of the long-to-short axis ratio of the patch antenna 10 are not more than those of the patch antenna including the dielectric antenna substrate.

As shown in FIG. 6, concerning the patch antenna including the dielectric antenna substrate and the patch antenna 10 in which the antenna substrate 11 is made of a magnetic composite having a ratio (εr:μr) of (80:20), (667:33.3), or (50:50), the distributions of Fr with respect to the shortening rate SR are obtained. In the patch antenna including the dielectric antenna substrate and the patch antenna 10 in which the antenna substrate 11 is made of a magnetic composite having a ratio (εr:μr) of (80:20), (66.7:33.3), or (50:50), as the shortening rate SR is reduced, Fr is reduced.

To summarize the analysis results of FIGS. 3 to 6, concerning the patch antenna 10, it is possible, as shown in FIG. 7, to obtain an application range of the feed angle F_{ang} with respect to the shortening rate SR in which good right circularly polarized waves are emitted at a frequency 1.575 [GHz]. The application range is a range in which the feed angle F_{ang} is larger than the characteristic curve (the approximate curve of the plotted points) of the feed angle F_{ang} with respect to the shortening rate SR in the patch antenna including the dielectric antenna substrate. The characteristic curve of the feed angle F_{ang} with respect to the shortening rate SR of the patch antenna including the dielectric antenna substrate is expressed by the following equation (5).

F_{ang} [deg.]=15 tan⁻¹(15SR−0.5)−17 (5)

Furthermore, the application range is set to such a range that the feed angle F_{ang} is larger than the curve of the equation (5) and the shortening rate SR which can provide preferable radiation efficiency in the analysis results of FIG. 4 is not more than 0.4. The patch antenna 10 is designed in this application range.

According to the first embodiment, the patch antenna 10 includes the antenna electrode 12, ground portion 13, antenna substrate 11, and feed point P (feed pin 14). The feed angle F_{ang} of the patch antenna 10 is larger than the characteristic curve expressed by the equation (5) of the feed angle F_{ang} of the patch antenna including the dielectric antenna substrate in terms of the feed angle F_{ang} with respect to the shortening rate SR. The patch antenna 10 in which the antenna substrate 11 is made of a magnetic composite can therefore provide good circularly polarized radiation (reception).

The shortening rate SR of the patch antenna 10 is not more than 0.4. Accordingly, the radiation efficiency of the patch antenna 10 can be made higher than that of the patch antenna including a dielectric antenna substrate.

### Second Embodiment

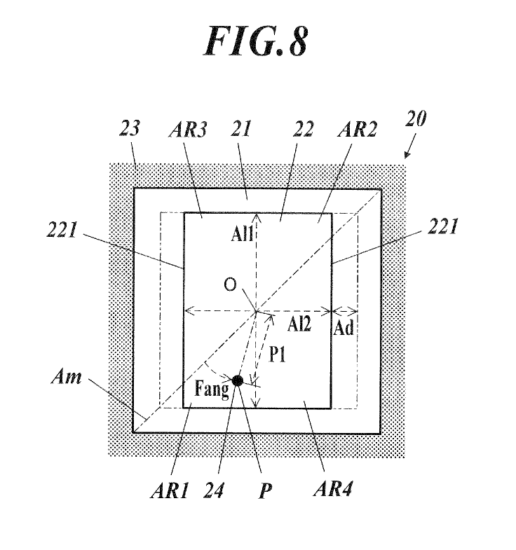

With reference to FIGS. 8 to 13, a description is given of a second embodiment of the present invention. First, with reference to FIG. 8, the device configuration of a patch antenna 20 as an antenna device of the second embodiment is described. FIG. 8 is a plan view of the patch antenna 20.

The patch antenna 20 of the second embodiment is a single-feed patch antenna of a rectangular model for communication by using right circularly polarized waves. In the example described herein, the patch antenna 20 is a GPS antenna, but the present invention is not limited to this.

As shown in FIG. 8, the patch antenna 20 includes an antenna substrate 21, an antenna electrode 22, a ground portion 23, and a feed pin 24.

The antenna substrate 21, the ground portion 23, and the feed pin 24 have the same configurations of the antenna substrate 11, the ground portion 13, and the feed pin 14 of the patch antenna 10 of the first embodiment, respectively.

The antenna electrode 22 is a metallic electrode of silver foil, copper foil, or the like which is formed on the upper surface of the antenna substrate 21. The antenna electrode 22 has a rectangular shape obtained by removing a pair of opposing sides from a square electrode and includes perturbation elements 221 as degeneracy separation elements.

Next, a description is given of parameters of each portion of the patch antenna 20. As shown in FIG. 8, the provision of the perturbation elements 221 causes two resonant modes in the antenna electrode 22. The antenna electrode 22 has a current route which is the longest in the electrode and a current route orthogonal to the longest current route. The electrode length of the longest current route is referred to as a long-axis length Al1. The electrode length of the current route orthogonal to the longest current route is referred to as a short-axis length Al2. By applying to the feed pin 24, antenna current having such a frequency that the amplitudes of the resonant modes of the long-axis length Al1 and the short-axis length Al2 are equal to each other and the phase difference therebetween is 90 degrees, circularly polarized radio waves are radiated from the patch antenna 20. The resonant modes of the long-axis length Al1 and the short-axis length Al2 are referred to as first and second modes, respectively.

The length of each perturbation element 221 on the extension of the line (short axis) having the short-axis length Al2 is referred to as a length Ad [mm]. The central point of the plane of the antenna electrode 22, which is an intersection of the short-axis and the axis (long axis) of the long-axis length Al1, is referred as a central point O.

Similarly to the antenna 10, the length of each side of the planar square of the antenna substrate is referred to as a length Ml [mm]. The length of each side of the ground portion 23 is referred to as a length Gl [mm] (=2×Ml). The thickness of the antenna substrate 21 is referred to as a thickness Mt [mm] (=2 [m]).

As shown in FIG. 8, Fr denotes the ratio of length P1 between the central point O and the feed point P to A1/2. Moreover, the middle axis between the long axis and the short axis is referred to as an axis Am. In a direction of counterclockwise rotation from the short axis to the long axis around the central point O, the angle of the feed point P from the axis Am as a standard is referred to as a feed angle F_{ang} [deg.]. Herein, the direction from the short axis to the long axis is set positive.

The design requirements of the patch antenna 20 are, similarly to the patch antenna 10, that good right circularly polarized waves are obtained at the frequency of the GPS signals of 1.575 [GHz]. Specifically, the deign requirements of the patch antenna 20 is that the equations (2) and (3) described above are satisfied at the frequency of 1.575 GHz. When the feed point P is provided in the area AR1 or AR2, the patch antenna 20 radiates right circularly polarized waves.

Next, a description is given of numerical values of the parameters of the patch antenna 20 in the case of varying the relative permittivity εr and the relative magnetic permeability μr of the antenna substrate 21. The antenna electrode 22 and the ground portion 23 are made of copper.

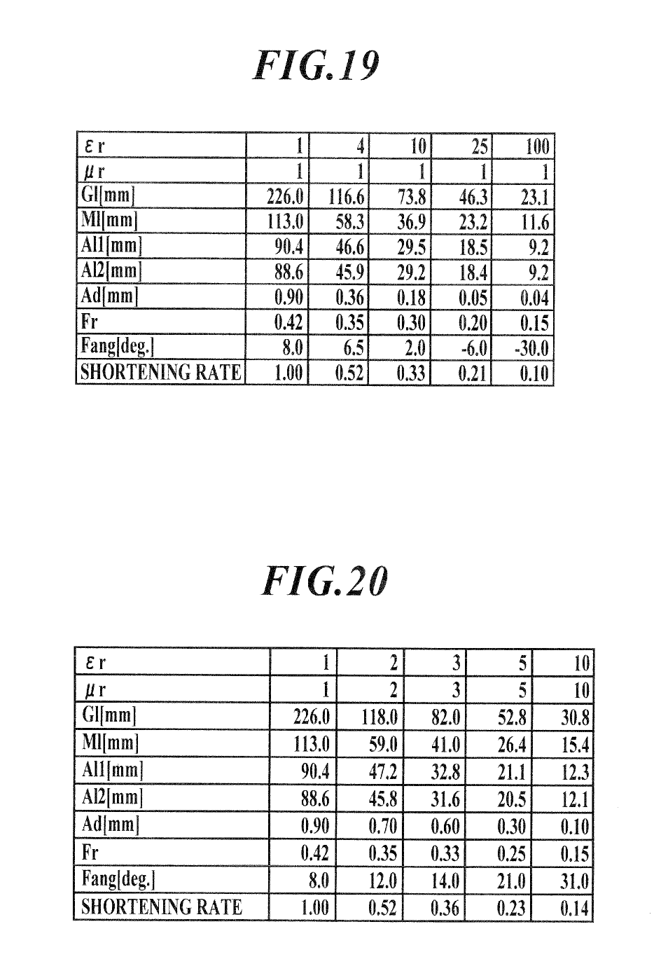

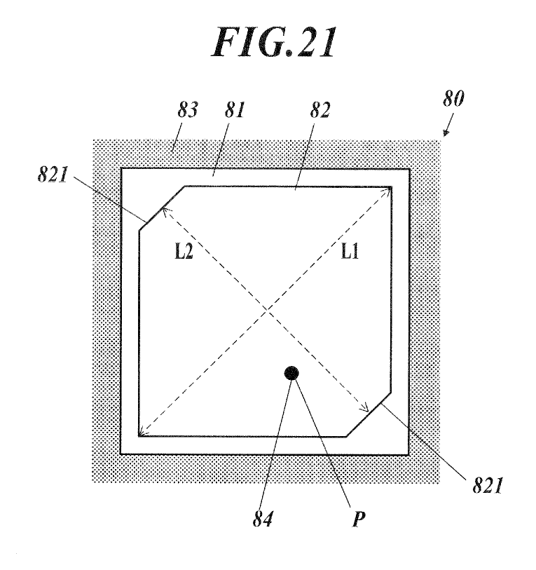

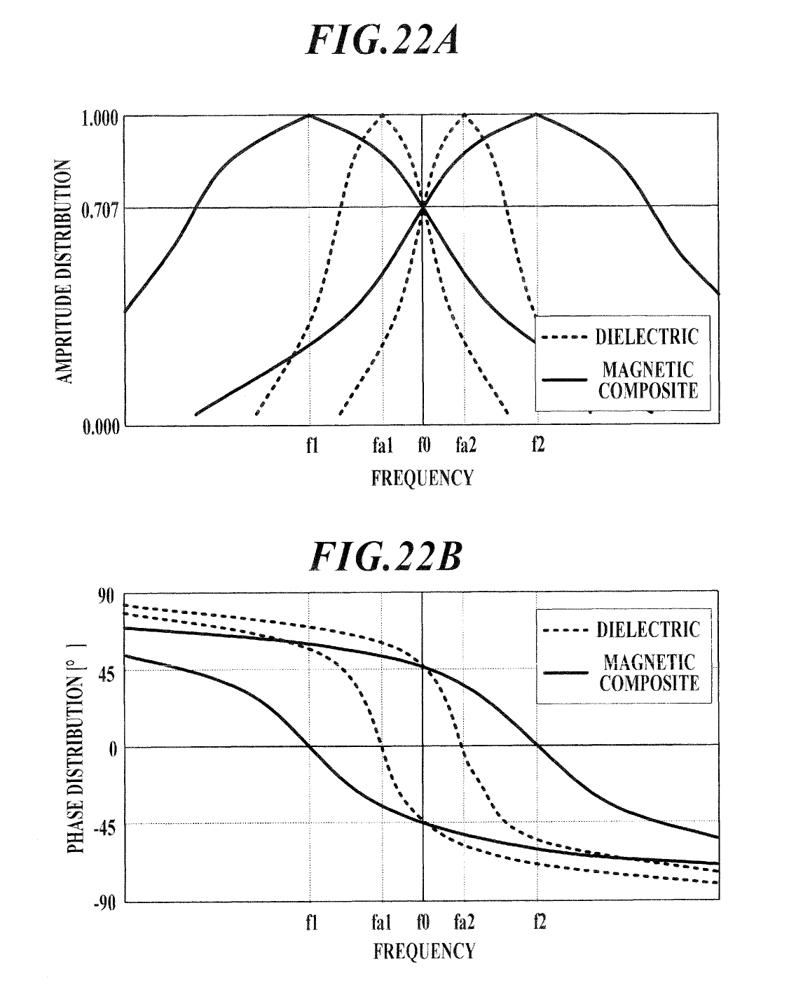

First, for comparison with the patch antenna 20, FIG. 19 shows numerical values of the fifth parameters of a patch antenna which has a same shape as the patch antenna 20 and includes an antenna substrate made of a dielectric. The relative permittivity εr of the dielectric is changed while the relative magnetic permeability μr is fixed to 1. The dielectric loss tan δε of the dielectric is set to 0.001, and the magnetic loss tan δμ of the same is set to 0.

FIG. 20 shows numerical values of the sixth parameters of the patch antenna 20 in which the antenna substrate 21 is composed of a magnetic composite having a ratio (εr:μr) of 50:50. The dielectric loss tan δε of the magnetic composite of the antenna substrate 21 is set to 0.001, and the magnetic loss tan δμ of the same is set to 0.001.

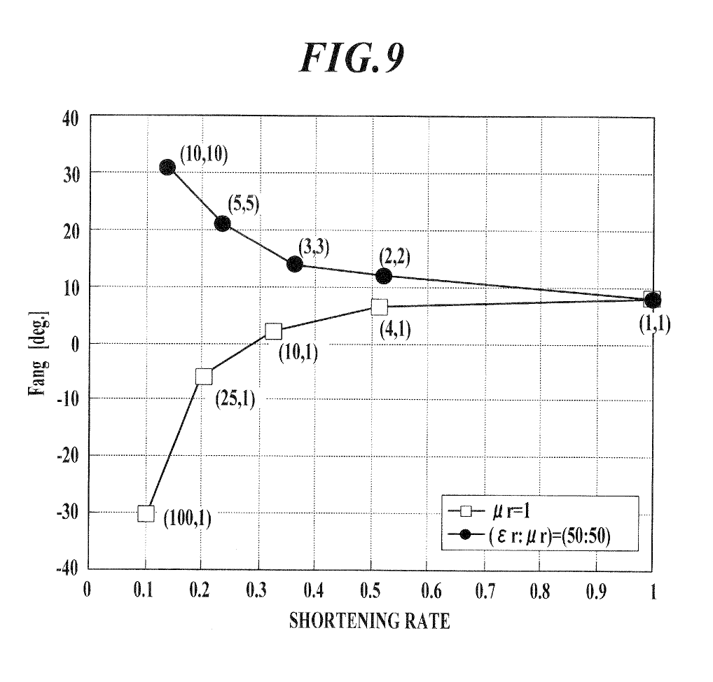

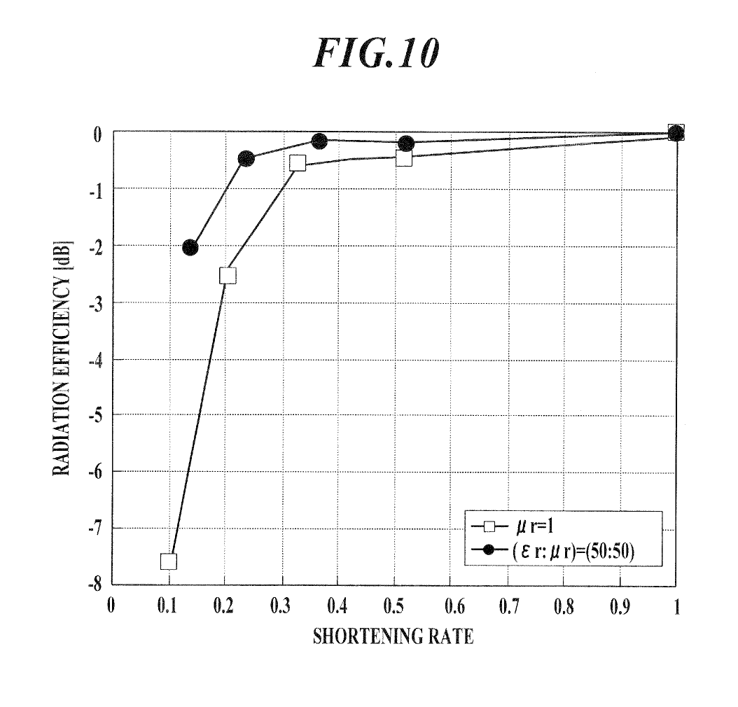

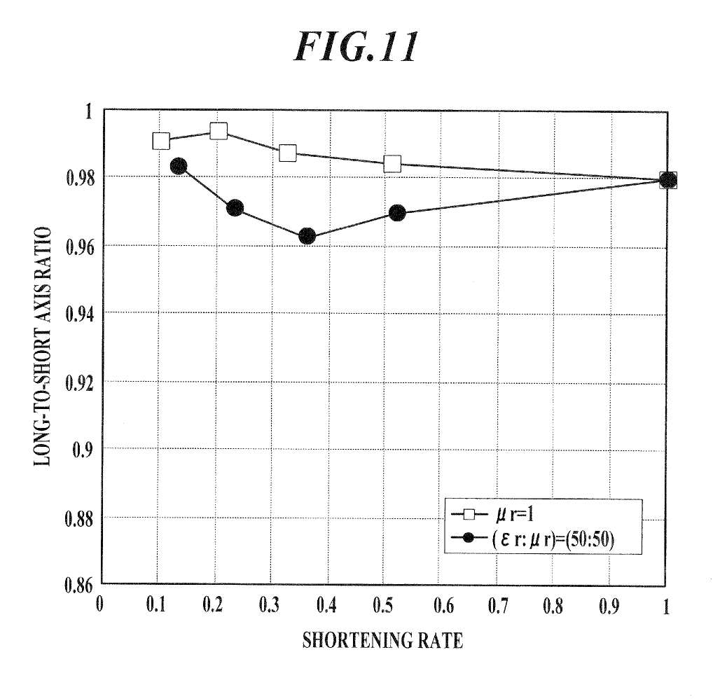

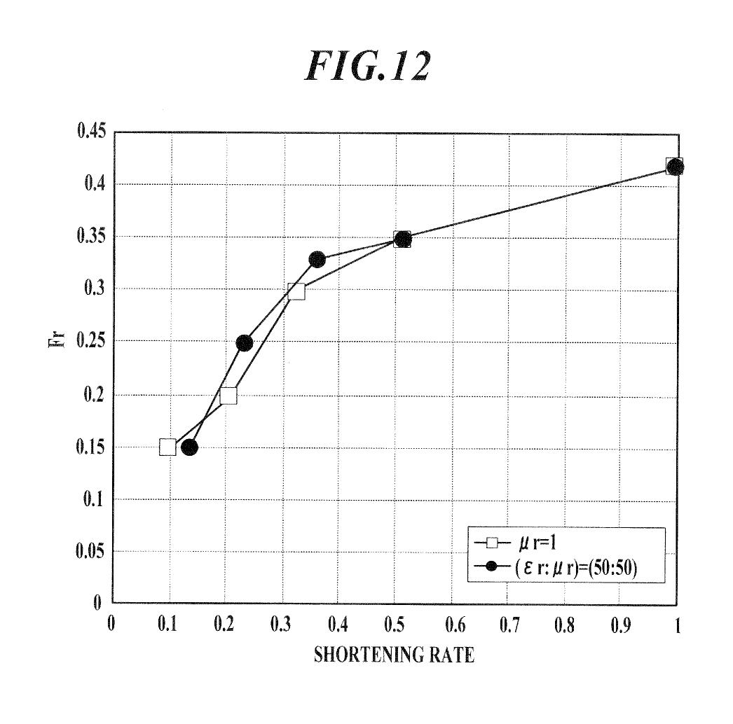

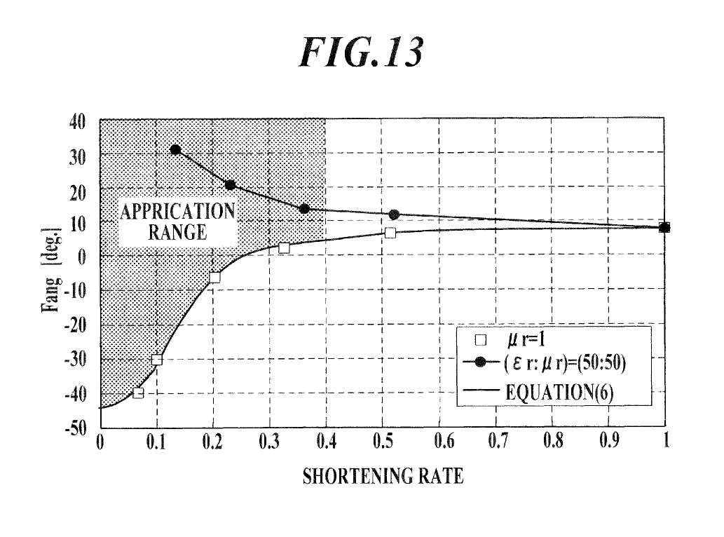

Next, with reference to FIGS. 9 to 13, a description is given of the analysis results of the antenna characteristics and parameters with respect to the shortening rate in the patch antenna including the dielectric antenna substrate and the patch antenna 20 which is described in FIGS. 19 and 20. FIG. 9 is a diagram showing distributions of the feed angle F_{ang} with respect to the shortening rate SR in the patch antenna including the dielectric antenna substrate and the patch antenna 20. FIG. 10 is a diagram showing distributions of the radiation efficiency with respect to the shortening rate SR in the patch antenna including the dielectric antenna substrate and the patch antenna 20. FIG. 11 is a diagram showing distributions of the long-to-short axis ratio with respect to the shortening rate SR in the patch antenna including the dielectric antenna substrate and the patch antenna 20. FIG. 12 is a diagram showing distributions of Fr with respect to the shortening rate SR in the patch antenna including the dielectric antenna substrate and the patch antenna 20. FIG. 13 is a diagram showing an application range (dotted area) of the feed angle F_{ang} with respect to the shortening rate SR concerning the patch antenna 20.

In FIGS. 9 to 13, concerning the patch antenna in which the antenna substrate is made of a dielectric and the patch antenna 20 in which the antenna substrate 21 is made of a magnetic composite having a ratio (εr:μr) of (50:50), the points satisfying the requirements to provide good right circularly polarized waves having a frequency of 1.575 [GHz], or satisfying the equations (2) and (3) at a frequency of 1.575 [GHz] are plotted. Concerning the respective plotted points, the higher the shortening rate, the lower the relative permittivity εr and the relative magnetic permeability μr, and the lower the shortening rate, the higher the relative permittivity εr and the relative magnetic permeability μr.

As shown in FIG. 9, concerning the patch antenna including the dielectric antenna substrate and the patch antenna 20 in which the antenna substrate 21 is made of a magnetic composite having a ratio (εr:μr) of (50:50), the distributions of the feed angle F_{ang} with respect to the shortening rate SR are obtained, As for the patch antenna including the dielectric antenna substrate, as the shortening rate SR decreases, the supply feed F_{ang} decreases. As for the patch antenna 20 having a ratio (εr:μr) of (50:50), as the shortening rate SR decreases, the feed angle F_{ang} increases. Moreover, the values of the feed angle F_{ang} of the patch antenna 20 are larger than those of the patch antenna including the dielectric antenna substrate.

As shown in FIG. 10, concerning the patch antenna including the dielectric antenna substrate and the patch antenna 20 having a ratio (εr:μr) of (50:50), the radiation efficiency relative to the shortening rate SR is obtained. In the patch antenna including the dielectric antenna substrate and the patch antenna 20 having a ratio (εr:μr) of (50:50), as the shortening rate SR decreases, the radiation efficiency decreases. When the shortening rate SR is reduced to 0.4 or less, in particular, the radiation efficiency is reduced drastically.

As shown in FIG. 11, concerning the patch antenna including the dielectric antenna substrate and the patch antenna 20 having a ratio (εr:μr) of (50:50), the distributions of the long-to-short axis ratio with respect to the shortening rate SR are obtained. The values of the long-to-short axis ratio of the patch antenna 20 are not more than those of the patch antenna including the dielectric antenna substrate.

As shown in FIG. 12, concerning the patch antenna including the dielectric antenna substrate and the patch antenna 20 having a ratio (εr:μr) of (50:50), the distributions of Fr with respect to the shortening rate SR are obtained. In the patch antenna including the dielectric antenna substrate and the patch antenna 20 having a ratio (εr:μr) of (50:50), as the shortening rate SR decreases, the value of Fr decreases.

To summarize the analysis results of FIGS. 9 to 12, concerning the patch antenna 20, an application range of the feed angle F_{ang} with respect to the shortening rate SR in which good right circularly polarized waves are radiated at a frequency 1.575 [GHz] is obtained as shown in FIG. 13. FIG. 13 is a diagram showing the distributions of the feed angle F_{ang} with respect to the shortening rate SR. The application range is a range in which the feed angle F_{ang} is larger than the characteristic curve (the approximate curve of the plotted points) of the feed angle F_{ang} with respect to the shortening rate SR in the patch antenna including the dielectric antenna substrate. The characteristic curve of the feed angle F_{ang} with respect to the shortening rate SR of the patch antenna including the dielectric antenna substrate is expressed by the following equation (6).

F_{ang} [deg.]=20 tan⁻¹(16SR−2.2)−22 (6)

Furthermore, the application range is set to a range in which the feed angle F_{ang} is larger than the characteristic curve of the equation (6) and the shortening rate SR which can provide preferable radiation efficiency is not more than 0.4 based on the analysis results of FIG. 10. The patch antenna 20 is designed in this application range.

According to the second embodiment, the patch antenna 20 includes the antenna electrode 22, the ground portion 23, the antenna substrate 21, and feed point P (feed pin 24). The feed angle F_{ang} of the patch antenna 20 is larger than the characteristic curve expressed by the equation (6) of the feed angle F_{ang} of the patch antenna including the dielectric antenna substrate in terms of the feed angle F_{ang} with respect to the shortening rate SR. Accordingly, the patch antenna 20 in which the antenna substrate 21 is made of a magnetic composite can implement good circularly polarized radiation (reception).

Moreover, the shortening rate SR of the patch antenna 20 is not more than 0.4. The radiation efficiency of the patch antenna 20 can be therefore made higher.

### (Modifications)

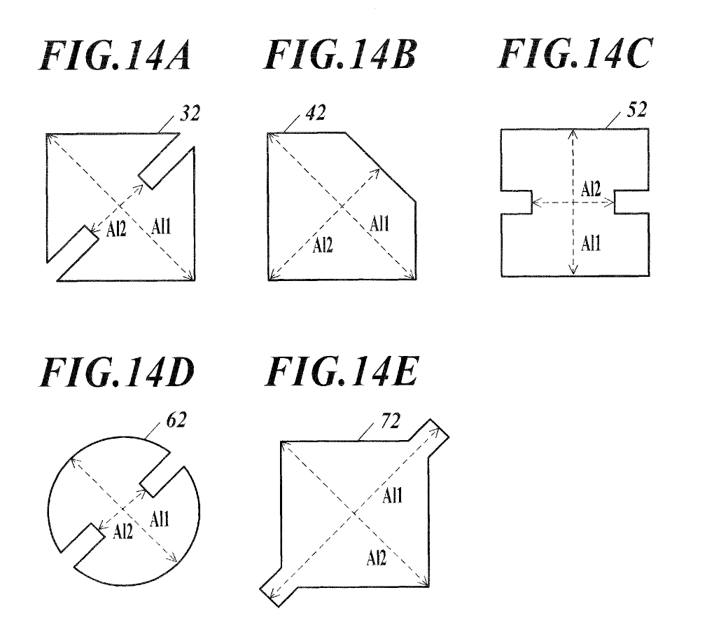

With reference to FIGS. 14A to 14E, a description is given of modifications of the above-described embodiments. FIG. 14A is a plan view of an antenna electrode 32 of a modification. FIG. 14B is a plan view of an antenna electrode 42 of another modification. FIG. 14C is a plan view of an antenna electrode 52 of still another modification. FIG. 14D is a plan view of an antenna electrode 62 of still another modification. FIG. 14E is a plan view of an antenna electrode 72 of still another modification.

In the patch antennas 10 and 20 of the above-described embodiments, each of the antenna electrodes 12 and 22 may be replaced with the antenna electrode 32 shown in FIG. 14A. The antenna electrode 32 includes the long-axis length Al1 and short-axis length Al2 orthogonal to each other.

Similarly, in the patch antennas 10 and 20 of the above-described embodiments, each of the antenna electrodes 12 and 22 may be replaced with any one of the antenna electrodes 42, 52, 62, and 72, which are shown in FIGS. 14B, 14C, 14D, and 14E, respectively. Each of the antenna electrodes 42, 52, 62, and 72 includes the long-axis length Al1 and short-axis length Al2 orthogonal to each other.

As for the feed angle F_{ang} of the patch antenna including the antenna electrode 32, 42, 52, 62, or 72, in a similar manner to the patch antennas 10 and 20 of the above-described embodiments, the feed angle F_{ang} with respect to the shortening rate SR is set larger than the characteristic curve of the feed angle F_{ang} of the patch antenna including the dielectric antenna substrate. Moreover, the shortening rate SR of the patch antenna including the antenna electrode 32, 42, 52, 62, or 72 is set not more than 0.4.

According to the modifications, with regard to the feed angle F_{ang} of the patch antennas 10 and 20, which respectively include the antenna substrates 11 and 21 made of magnetic composites and include the antenna electrodes 32, 42, 52, 62, or 72, the feed angle F_{ang} with respect to the shortening rate SR is set larger than the characteristic curve of the feed angle F_{ang} of the patch antenna including the dielectric antenna substrate. Accordingly, similarly to the patch antennas 10 and 20 of the aforementioned embodiments, the patch antenna which includes the antenna electrode 32, 42, 52, 62, or 72 and the antenna substrate made of a magnetic composite can implement good circularly polarized radiation (reception).

Moreover, the shortening rate SR of the patch antenna including the antenna electrode 32, 42, 52, 62, or 72 is not more than 0.4. The radiation efficiency of the patch antenna including the antenna electrode 32, 42, 52, 62, or 72 can be therefore made higher.

The above-described embodiments and modifications are just examples of the patch antenna according to the present invention, and the present invention is not limited to the above description.

The aforementioned embodiments and modifications show the requirements for the patch antenna at the frequency of GPS signals of 1.575 [GHz]. However, the present invention is not limited to this frequency. If the frequency changes, the patch antenna (each parameter there) may be scaled corresponding to the changing frequency.

The aforementioned embodiments and modifications show the requirements for the patch antenna performing right circularly polarized communication. However, the present invention is not limited to this. To perform left circularly polarized communication, in the patch antennas 10 and 20, the feed point P may be provided in the area AR3 or AR4. Moreover, in a direction of clockwise rotation from the short axis to the long axis around the central point O, the angle of the feed point P with respect to the axis Am may be set as the feed angle F_{ang} [deg.]. Herein, the direction from the short axis to the long axis is set positive. In other words, in right and left circularly polarized waves, the positions of the feed point P are line-symmetric with respect to the long axis.

The other detailed configurations and operations of the patch antennas 10 and 20 of the aforementioned embodiments can be properly changed without departing from the spirit and scope of the present invention.

It should be considered that the embodiments and modifications disclosed herein are shown by way of example in all respects and are not restrictive. The scope of the present invention is not prescribed by the above description but prescribed by claims and includes the equivalents to the claims and all the changes within the scope.

The entire disclosure of Japanese Patent Application No. 2012-019505 filed on Feb. 1, 2012 including description, claims, drawings, and abstract is incorporated herein by reference in its entirety.

What is claimed is:

1. An antenna device, comprising:
a planar antenna electrode;
a planar ground portion;
an antenna substrate which is sandwiched by the antenna electrode and the ground portion and is made of a magnetic composite containing a dielectric and a magnetic material; and
a feed point connected to the antenna electrode, wherein
a feed angle which is an angle of the feed point is larger than a characteristic curve of a feed angle of a patch antenna having an antenna substrate composed of only a dielectric in terms of the feed angle with respect to a shortening rate based on a relative permittivity and a relative magnetic permeability of the antenna substrate, the feed angle being an angle based on a middle axis between a long axis and a short axis in a direction of rotation from the short axis to the long axis around a central point of the plane of the antenna electrode, the long axis being a current route which is the longest in the antenna electrode, the short axis being orthogonal to the long axis.

2. The antenna device according to claim 1, wherein
the antenna electrode has a shape of a square electrode with a pair of opposing corners thereof removed, and
the characteristic curve of the feed angle of the patch antenna including the antenna substrate composed of only the dielectric is expressed as:
F_{ang} [deg.]=15 tan⁻¹(15SR−0.5)−17
where F_{ang} is the feed angle and SR is the shortening rate.

3. The antenna device according to claim 1, wherein
the antenna electrode is a rectangular electrode, and
the characteristic curve of the feed angle of the patch antenna including the antenna substrate composed of only the dielectric is expressed as:
F_{ang} [deg.]=20 tan⁻¹(16SR−2.2)−22
where F_{ang} is the feed angle and SR is the shortening rate.

4. The antenna device according to claim 1, wherein the shortening rate based on the relative permittivity and the relative magnetic permeability of the antenna substrate is not more than 0.4.
